(19) United States
(12) Patent Application Publication
(10) Pub. No.: US 2022/0225804 A1
(43) Pub. Date: Jul. 21, 2022

(54) PORTABLE AND MODULAR COVER

(71) Applicant: Scott E Thayer, Reading, MA (US)

(72) Inventor: Scott E Thayer, Reading, MA (US)

(21) Appl. No.: 17/579,094

(22) Filed: Jan. 19, 2022

Related U.S. Application Data
(60) Provisional application No. 63/139,765, filed on Jan. 20, 2021.

(51) Int. Cl. A47G 19/26; A01G 9/14; A01G 9/20

(52) U.S. Cl. CPC A47G 19/26; A01G 9/20; A01G 9/1407; A01G 9/1438

(57) ABSTRACT

A cover, and more particularly, a portable modular cover that may be assembled outdoors to keep insects and/or the elements from contacting food or other items spread out across small or large areas, and that may also be disassembled for ease of storage and transport, is disclosed. The portable modular cover provides solutions for protecting such food or other items through separate embodiments that are lightweight, durable, easy to assemble, and easy to travel with for virtually any occasion. When disassembled, the portable modular cover can easily fit within any suitable carrying case for ease of transport. Assembling the components together can be done on the fly at any outdoor event without requiring extraneous tools such as wrenches or screwdrivers. Opening and closing the portable modular cover can be done quickly and with ease to minimize exposure of food or other contents when accessing. Other optional accessories such as internal light fixtures can accommodate its use at evening outdoor events.

### CROSS-REFERENCE TO RELATED APPLICATIONS

The present application claims priority to U.S. Provisional Patent Application No. 63/139,765 filed on Jan. 20, 2021, and entitled “Portable and Modular Cover,” which is incorporated herein by reference in its entirety.

### BACKGROUND OF THE INVENTION

### 1. Field of the Invention

The present invention relates to a cover, and more particularly, to a portable modular cover that may be assembled outdoors to keep insects and/or the elements from contacting food or other items spread out across small or large areas, and that may also be disassembled for ease of storage and transport.

### 2. Background

Eating outdoors is a common pastime, be it a picnic lunch, backyard barbeque, camping, or special outdoor event. But regardless of the occasion, to protect food and gear from the elements such as insects and pests, sand, dust, pollen, the sun, rain, or an ill-timed sneeze or cough, many rely on makeshift food covers that may be flimsy, difficult to keep in place under certain conditions, are too small, or are visually unattractive.

The present invention provides solutions through multiple embodiments for a portable and modular cover that are lightweight, durable, easy to assemble, and easy to travel with for virtually any outdoor occasion.

When disassembled, the modular covers of embodiments of the present invention can easily fit within any suitable carrying case for ease of transport. And assembling the components together can be done on the fly at any outdoor event without requiring extraneous tools such as wrenches or screwdrivers. As a result, the present invention provides on-the-go and portable covers for food or other items that not only protects such items from outdoor pests or weather, but may also provide a visually attractive covering that can be customized for a variety of personal tastes and occasions.

The present invention opens and closes with ease to minimize exposure of food or other contents when accessing. Other optional accessories such as internal light fixtures can accommodate its use at evening outdoor events.

### OBJECTS AND SUMMARY OF THE INVENTION

This summary is not intended to identify or point to essential features or limit the scope of the subject matter now or later claimed based on the disclosure herein. The present invention relates to a portable modular cover and methods to protect, store, cover, and display food or other items, with certain embodiments achieving one or more of the following objectives:

To facilitate ease of assembly and disassembly of the cover without use of any extraneous tools such as wrenches or screwdrivers;

To enable size adjustments to accommodate food or other items of various sizes, shapes, and quantities;

To minimize storage space and facilitate portability of the disassembled cover in a carrying case;

To protect food or other items in a closed configuration of the cover from insects, rain, sun, wind, morning dew, pollen, dust, pollutants, and/or other debris;

To enable quick switching of the cover between open and closed configurations in which food or other items spread out over small or large surface areas may be intermittently and swiftly accessed and covered in an outdoor environment;

To provide a cover configurable to an open configuration which allows access to food or other items spread out over a small or large surface area, and a closed configuration which both protects and displays the food or other items through a transparent or perforated protective covering over the small or large surface area; and

To prevent or minimize movement or disruption of the cover or items stored therein by wind or other elements in an outdoor setting.

In accordance with one aspect of certain embodiments of the invention, a cover apparatus includes a top assembly pivotally and detachably coupled to a bottom assembly, and a protective covering detachably coupled to the top assembly. The bottom assembly includes a bottom frame with a plurality of detachable members and at least one bracket and hinge portion coupled to the bottom frame. The bottom frame is configured for placement on a substantially horizontal surface, and defines an interior space for receiving food and other items.

The top assembly in certain embodiments may include a top-peripheral frame with a plurality of detachable members, a plurality of brackets, and a top-center frame. The top-center frame includes a center member and a plurality of transverse members extending between and detachably coupled to the plurality of brackets of the top-peripheral frame and the center member. The protective covering detachably couples to the top-peripheral frame, and is supported and shaped by the top-center frame. During operation, the top assembly and attached protective covering are pivotable together about the bottom assembly to move the cover between open and closed configurations.

In certain embodiments, the plurality of transverse members of the top-center frame are each spring biased toward a straight elongated orientation in a relaxed unloaded state. During assembly, the plurality of transverse members of the top-center frame are each bendable into an arcuate shape when connected to the center member and one of the plurality of brackets of the top-peripheral frame, and thus are in compression when operatively disposed between the center member and the top-peripheral frame. Once assembled, the transverse members can define convex outer surfaces which support the protective covering, thereby providing additional clearance between the protective covering and food or other items placed within the cover. In certain embodiments, the transverse members may converge at the center member and diverge toward corner brackets of the top-peripheral frame, and may be used to adjust the height of the protective covering relative to the base frame depending on the spacing or footprint utilized for the base frame.

In certain embodiments, a cover apparatus or assembly comprises a bottom frame and a top frame, each comprising a plurality of members that are advantageously and rotatably coupled together to facilitate ease of compact transport when disassembled. Transverse members or rods in a loaded state may define a domed convex area upon which a protective covering can extend over. The protective covering may wrap around both the bottom frame and top frame to form a surface underneath the bottom frame that facilitates the placement of food or other items thereon.

Various other objects, advantages, features, and characteristics of the present invention, as well as the methods of operation and functions of related structural elements, and the combination of parts and economies of development and manufacture, will become readily apparent to those of ordinary skill in the art upon consideration of the detailed description below with reference to the accompanying drawings, all of which form a part of this specification.

### BRIEF DESCRIPTION OF THE DRAWINGS

A further understanding of the present invention can be obtained by reference to preferred embodiments set forth in the illustrations of the accompanying drawings. The drawings are not intended to limit the scope of this invention, but merely to clarify and exemplify the invention. Accordingly, a more complete appreciation of the present invention and many of the attendant aspects thereof may be readily obtained as the same becomes better understood by reference to the following detailed description when considered in conjunction with the accompanying drawings, where:

FIG. 1 is a front perspective view of an assembled cover in an open configuration in accordance with various embodiments of the invention;

FIG. 2 is a side perspective view of the cover of FIG. 1;

FIG. 3 is a front perspective view of the cover of FIG. 1 in a closed configuration;

FIG. 4A is a top perspective view of a bottom assembly of the cover of FIG. 1, showing detachable components thereof;

FIG. 4B is an illustration showing several top views of different embodiments of a bottom frame of the bottom assembly, which may include one or more detachably coupled intermediary pieces;

FIG. 4C is an illustration showing a top view of a rear corner bracket of the top-peripheral assembly, and a gas spring coupled to the rear corner bracket and mounted to the bottom frame, in accordance with various embodiments of the invention;

FIG. 4D is a top perspective view of a gas spring mount and a rear corner hinge affixed to a rear corner member of the bottom frame of the bottom assembly;

FIG. 4E is a perspective view of a mounting bracket attached to the bottom frame, with a first end of the gas spring coupled thereto, and a second end of the gas spring attached to a corner bracket of the top-peripheral assembly, in accordance with various embodiments of the invention;

FIG. 4F is an illustration showing a cut side view and a cut side perspective view of a clip attachment mounting the base frame of the cover to a table;

FIG. 5A is a front perspective exploded view of the top-peripheral frame of the top assembly, including front and rear corner brackets and peripheral front, rear, and side rods which detachably couple to the front and rear corner brackets;

FIG. 5B is an illustration showing several top views of different embodiments of the top-peripheral frame of the top assembly, including one or more detachably coupled intermediary pieces;

FIG. 5C is an enlarged perspective view of a rear corner bracket of the top-peripheral assembly of the cover;

FIG. 5D is an enlarged perspective view of a rear corner bracket of the top-peripheral frame, with peripheral and transverse rods attached thereto;

FIG. 5E is a cut side view of a portion of the top and bottom assemblies connected to one another via a rear corner bracket of the top assembly and a rear corner hinge and bracket of the bottom assembly affixed to a rear corner member of the base frame, in accordance with various embodiments of the invention;

FIG. 6A is a front perspective exploded view of the top-center frame and front and rear corner brackets of the top-peripheral frame, showing the transversely extending rods in a relaxed unassembled state;

FIG. 6B is an illustration showing several top views of various embodiments of the top-center frame, including one or more detachably coupled intermediary pieces, in accordance with various embodiments of the invention;

FIG. 6C is an illustration showing top and side views of a center member (cap), with the center member defining tapered conical recesses into which respective ends of the transverse rods of the top-center frame extend;

FIG. 7 is an alternative embodiment of a cover assembly and an exemplary carrying case that may be used to transport the cover assembly;

FIGS. 8A-B illustrate an alternative embodiment to the cover assembly of FIG. 7 in open and closed configurations;

FIG. 8C illustrates a perspective view of a gas spring that may be coupled to the embodiments illustrated in FIG. 7 or FIGS. 8A-B.

FIG. 9 is a front perspective view of another alternative embodiment of a cover assembly in an open configuration;

FIG. 10 is a front perspective view of the cover assembly of FIG. 9 in a closed configuration;

FIG. 11 is a front perspective view of the cover assembly of FIG. 9 in a closed configuration with the top portion of its protective covering removed;

FIG. 12 shows components of the top frame and bottom frame of the cover assembly of FIG. 9;

FIG. 13 shows components of the top frame and bottom frame of the cover assembly of FIG. 9 after being partially rotated about their respective hinges;

FIG. 14 shows components of the top frame, bottom frame, transverse detachable rods, and protective cover of the cover assembly of FIG. 9 in a disassembled state;

FIG. 15 shows a protective covering for use with the cover assembly of FIG. 9;

### DETAILED DESCRIPTION OF THE PRESENT INVENTION

The present disclosure is not intended to be limited to the specific terminology so selected, and it is to be understood that each specific element includes all technical equivalents which operate in a similar manner. Specific embodiments that may be practiced are shown by way of illustration and explanation. The embodiments are described in sufficient detail to enable those skilled in the art to practice the embodiments, and it is to be understood that logical, mechanical, and other changes may be made without departing from the scope of the embodiments. The following detailed description is therefore not to be taken in a limiting sense. In describing exemplary embodiments of the present invention illustrated in the drawings, specific terminology is employed for sake of clarity.

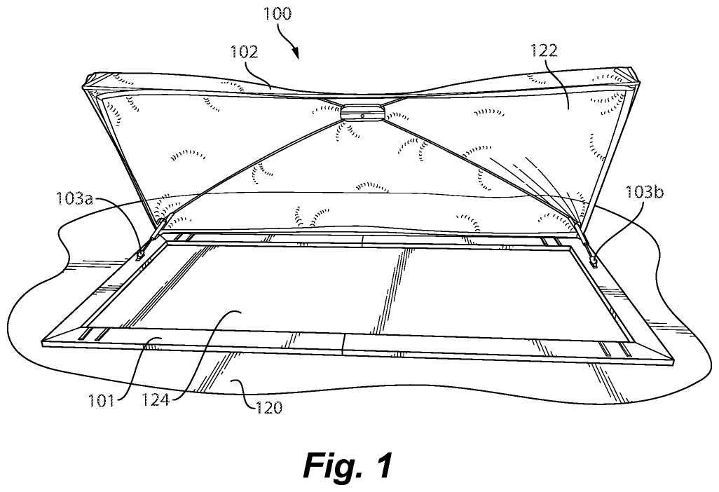

Referring to FIGS. 1-3, a cover or cover assembly 100 includes a bottom assembly 101 configured for placement on top of and supported by a horizontal flat surface 120 (e.g., a picnic table, a folding table, a dining table, or a work station), a top assembly 102 pivotally coupled to bottom assembly 101, and a protective covering 122 for protecting food or other items placed within cover assembly 100 from insects, rain, sun, wind, morning dew, pollen, dust, pollutants, and/or other debris. Cover assembly 100 may be used, for example, for backyard parties, picnics, camping, sporting events, tailgating, gardening, and other functions, either inside or outside.

As further explained herein, cover assembly 100 is modular and easily buildable, expandable, and contractible to accommodate varying sizes of tables and/or food or other items. Structural aspects of various brackets and connection mechanisms described herein facilitate this modularity, assembly, and disassembly of cover assembly 100 without the use of wrenches, screwdrivers, or other extraneous tools. The structural aspects described herein also allow for changes in dimensions of the cover assembly's length, width, and height, and provide stability when assembled. Use of lightweight, durable materials facilitate storage and portability of the cover assembly's components in a relatively small carrying case. During operation, cover assembly 100 can be used to quickly access and then cover various types of food before flies or other insects gain access thereto, while maintaining visibility of the food or other items in both open and closed configurations for presentation purposes. In other embodiments, protective covering 122 may be opaque and/or decorative.

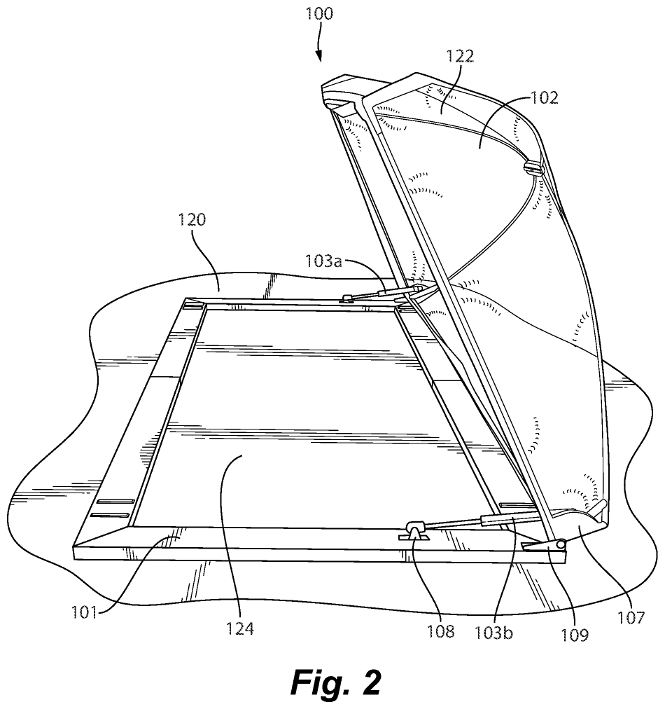

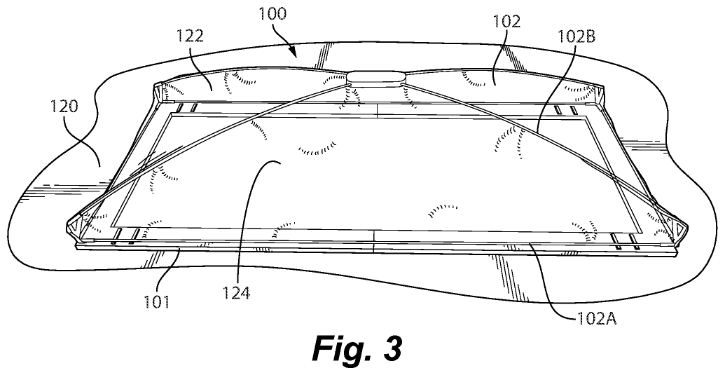

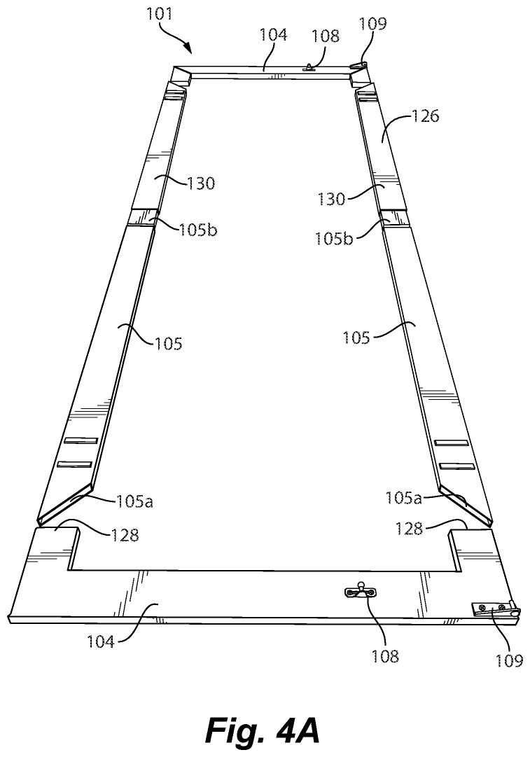

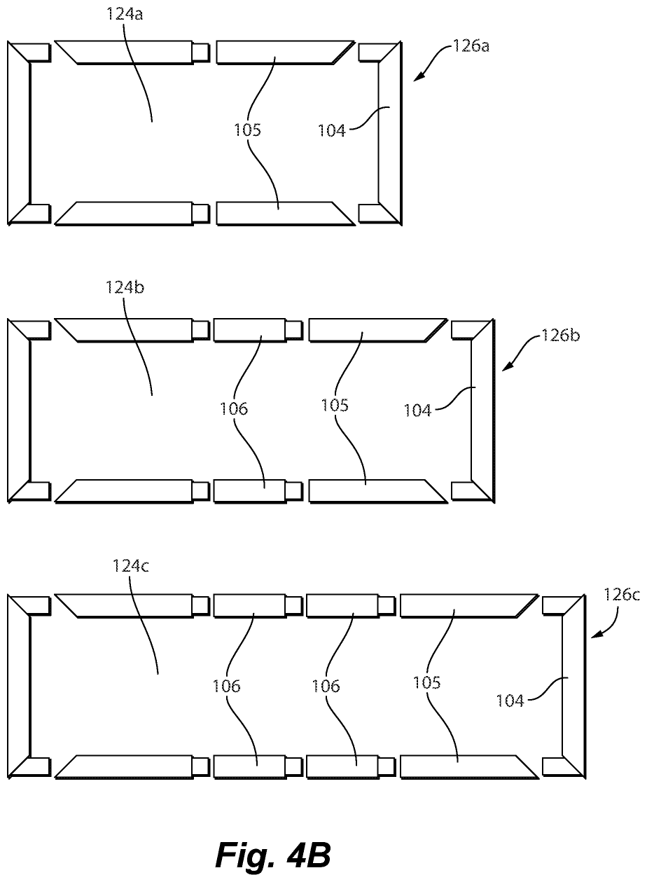

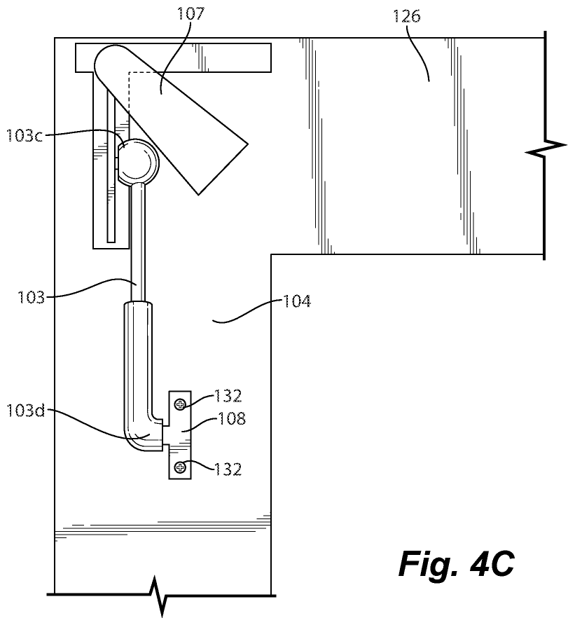

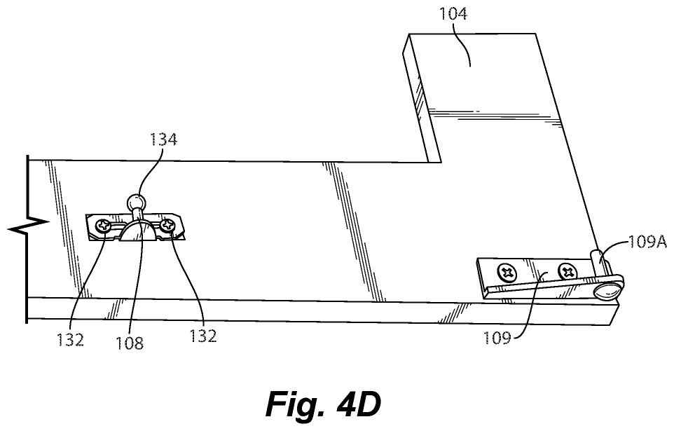

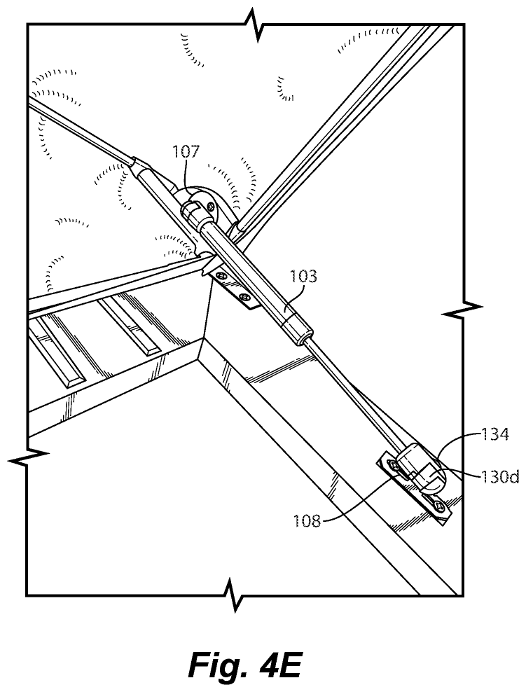

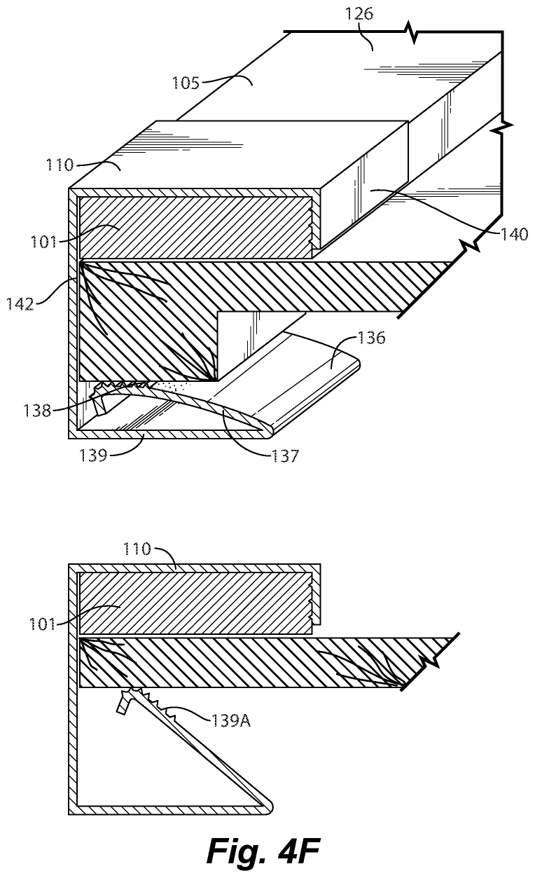

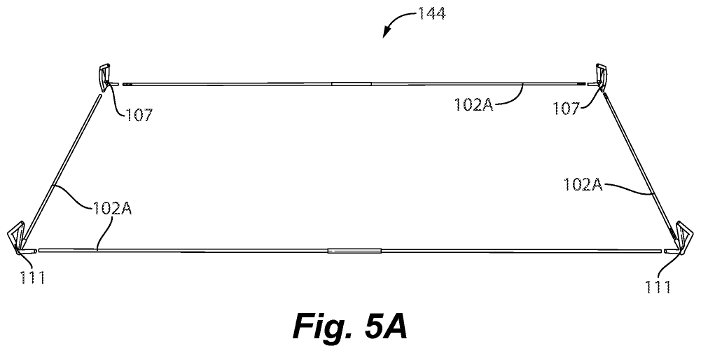

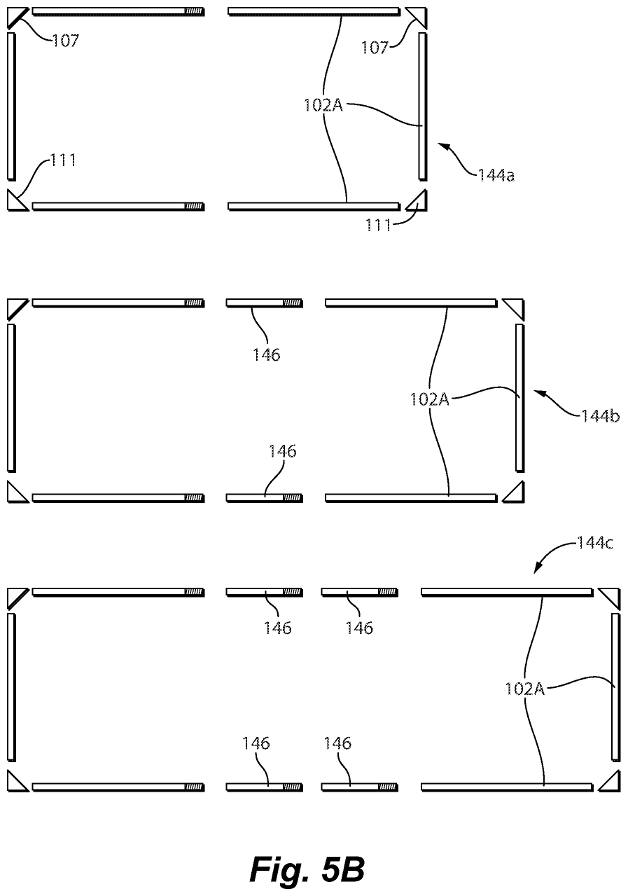

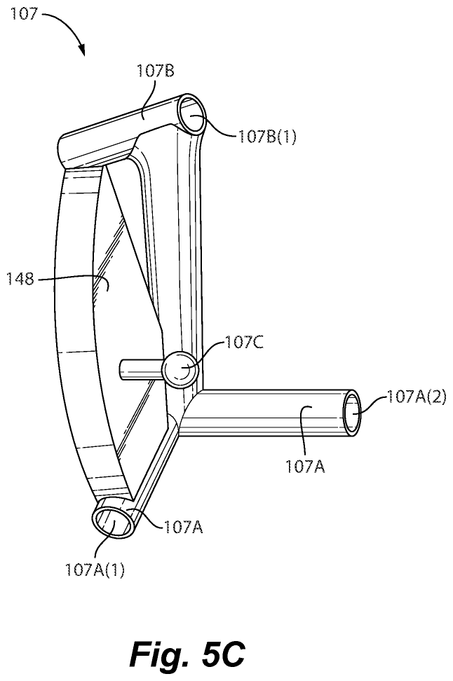

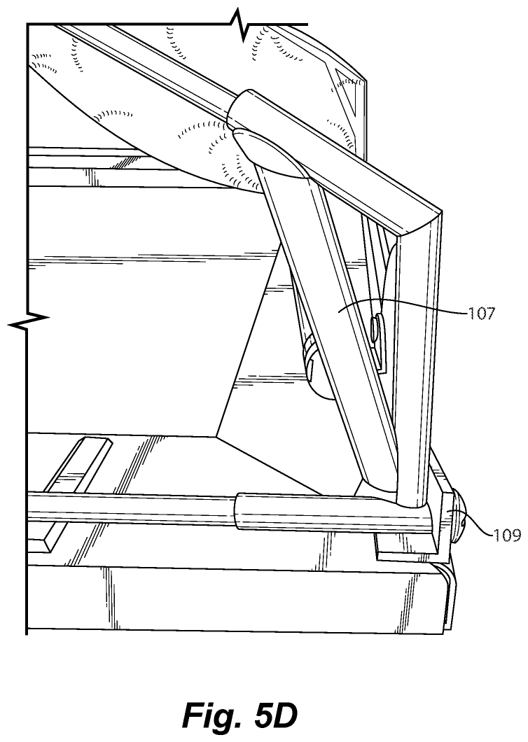

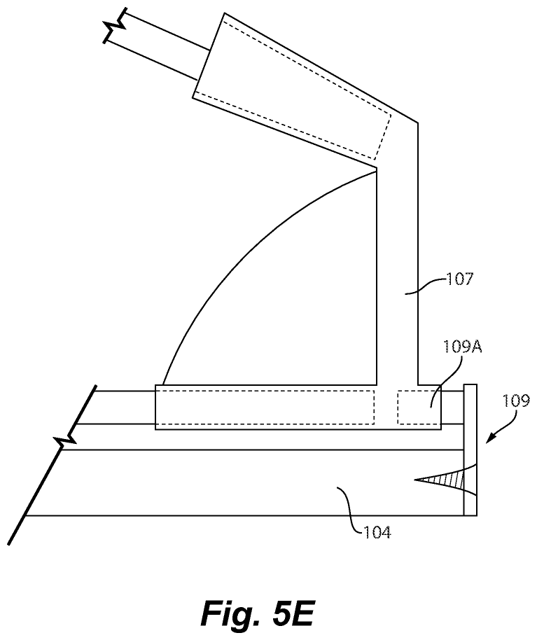

Cover assembly 100 is configurable to an open configuration (FIGS. 1-2) in which food or other items may be placed on flat surface 120 with an internal area 124 defined by bottom assembly 101. Cover assembly 100 is also configurable to a closed configuration (FIG. 3) in which protective covering 122 covers any items placed within internal area 124. One or more gas springs 103a, 103b enable cover assembly 100 to stay in its open configuration without user engagement, and facilitate a smooth opening and closing of cover assembly 100. Bottom and top assemblies 101, 102 are preferably pivotally coupled by one or more hinges 109A (FIGS. 4D, 5E). As best shown in FIG. 3, in the closed configuration, top assembly 102 overlaps bottom assembly 101 along its rectangular outer periphery to ensure that food or other objects placed within cover assembly 100 are sufficiently protected from external elements.

Referring to FIG. 4A with continued reference to FIGS. 1-3, bottom assembly 101 includes a bottom frame 126 having elongate detachable side members 104 and elongate detachable front and rear members 105. Elongate detachable side members 104 preferably have receiving ends 128 configured to receive narrower ends 105a of elongate detachable members 105 via press or interference fit. By way of example, front and rear members 105 may be configured with a tapered first end 105a and a second end 105b of the same width as an attaching secondary front or rear member 130. Secondary detachable members 130 may be connected to opposite ends of other elongate detachable front and rear members 105. The friction between attached elongate detachable members 104, 105 and secondary members 130 securely affixes them together without the need for any additional tools or hardware. Other suitable attachment mechanisms may be utilized.

In this manner, bottom frame 126 is expandable or reducible to increase or decrease the overall footprint or internal area 124 defined by bottom frame 126. It will be appreciated that in certain embodiments, bottom frame 126 may be assembled using only a single pair of front and rear members 105 and a single pair of side members 104. In certain embodiments, bottom assembly 101 includes one or more mounting brackets 108 and a hinge portion 109A (as highlighted, for example, in FIGS. 4D, 5E) of plastic hardware or bracket 109 which are preferably mounted to side members 104 of bottom frame 126. Bottom frame 126 may be made of a series of lightweight tubular PVC or similar plastic, tubular aluminum, or tubular stainless-steel members that can be connected to form a rectangular frame.

Referring to FIG. 4B, bottom frame 126 may be also constructed using configurations 126a, 126b, 126c. Intermediary members 106 are utilized to increase the modularity of bottom frame 126 and enable resizing of the overall footprint of cover 100. As shown, bottom frame 126a does not have any intermediary members 106 attached thereto, bottom frame 126b has two intermediary members 106 attached thereto, and bottom frame 126c has four intermediary members 106 attached thereto. In this manner, optional intermediate detachable members 106 may be utilized to increase or decrease the width of bottom frame 126, and by extension, the overall interior area 124a, 124b, 124c for receiving food items.

Referring now to FIG. 4C, bottom assembly 101 further includes a rear corner bracket 107 attached to gas spring 103. Rear corner bracket 107 may be made of plastic and manufactured via injection molding, 3D printing, or resin casting. Alternatively, bracket 107 may be made of metal which is preferably lightweight so as not to significantly increase the weight of cover 100 when carried in an unassembled state. Gas spring 103 attaches at a first end 103c to rear corner bracket 107, and at a second end 103d to mounting bracket 108, which is mounted by one or more screws 132 to side member 104 of bottom frame 126. Preferably, corner bracket 107 and mounting bracket 108 remain affixed to side member 104 even when cover assembly 100 is disassembled in order to simplify assembly and disassembly and avoid the need for extraneous tools or hardware.

Referring to FIGS. 4D-4E, as discussed above, mounting bracket 108 may be formed from plastic or other suitable material, and may be more permanently (yet still detachably) affixed to side member 104 via screws 132. Mounting bracket 108 and rear corner bracket 107 (further discussed below—see also, FIG. 2) of top assembly 102 are used to secure gas spring 103 and rear corner bracket 107 into place. For example, first end 103d of gas spring 103 fits over and preferably snaps onto a knob portion 134 of plastic hardware 108. Gas spring 103 preferably snap fits to mounting bracket 108 and rear corner bracket 107 (by way of knob portion 107C as shown in FIG. 5C). A side portion of rear corner bracket 107 can fit over a rotating hinge portion 109A of plastic hardware 109, whereby top assembly 102 can pivot relative to bottom assembly 101 to move cover 100 from the open configuration to the closed configuration, with gas spring 103 providing a dampening force during closing, and a retaining force once cover 100 is open until manually pulled closed.

Referring now to FIG. 4F, in certain embodiments, a hold down clip 110 is provided which may hook around a portion of, for example, front member (or other elongate member) 105 of bottom frame 126 of bottom assembly 101. Hold down clip 110 may include a spring biased bottom retaining portion 136 having a top flange 137 compressible underneath an underside surface 138 of, for example, a tabletop edge or other edge having thickness sufficient to compress top flange 137 relative to a bottom flange 139 thereof. Retaining portion 136 is thus spring biased toward a more open configuration, and grips underside surface 138 with grips 139A when hold down clip 110 is hooked to the table. Hold down clip 110 also includes an L-shaped top portion 140 configured to hook onto elongate member 105 by press or interference fit, and a straight portion 142 connecting L-shaped top portion 140 and retaining portion 136. Straight portion 142 extends generally flush with a side edge defined by a side of elongate member 105 and the table as shown. It will be appreciated that hold down clip 110 functions to help secure cover assembly 100 in place on the table or working surface on which it is placed. Multiple hold down clips 110 may be utilized. In other embodiments, straps, Velcro, or other suitable hold down mechanisms may be utilized.

Referring now to FIG. 5A, top assembly 102 includes a top-peripheral assembly (also described herein as a top-peripheral frame) 144 having rear corner brackets 107, front corner brackets 111, and a plurality of detachable members or rods 102A. Detachable rods 102A may be configured as elongate tubular members which threadably engage with tubular receiving sections defined by corner brackets 107 and front corner brackets 111 to form a rectangular peripheral edge to which protective covering 122 (FIGS. 1-3) is attached. Detachable rods 102A may be resilient or spring biased and bendable, but preferably maintain their substantially straight configuration in both assembled and disassembled configurations of the cover assembly 100. In certain embodiments, rods 102A may be lightweight fiberglass rods.

Referring to FIG. 5B, top-peripheral frame 144 may be constructed using configurations 144a, 144b, 144c. Front and rear corner brackets 111, 107 are shown schematically. Intermediary members 146 are utilized to increase the modularity of top peripheral frame 144 and enable resizing thereof in harmony with the overall footprint of bottom frame 126 (FIG. 4B). As shown, top-peripheral frame 144a does not have any intermediary members 146 attached thereto, top-peripheral frame 144b has two intermediary members 146 attached thereto, and top-peripheral frame 144c has four intermediary members attached thereto. In this manner, optional intermediary members 146 may be utilized to increase or decrease the width of top-peripheral frame 144. In certain embodiments, detachable rods 102a and intermediary members 146 are threadably engaged with one another as shown.

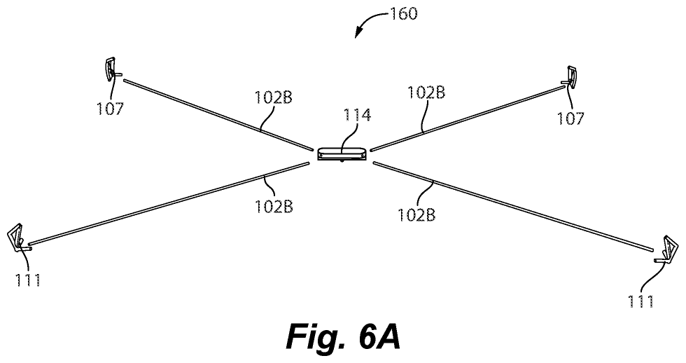

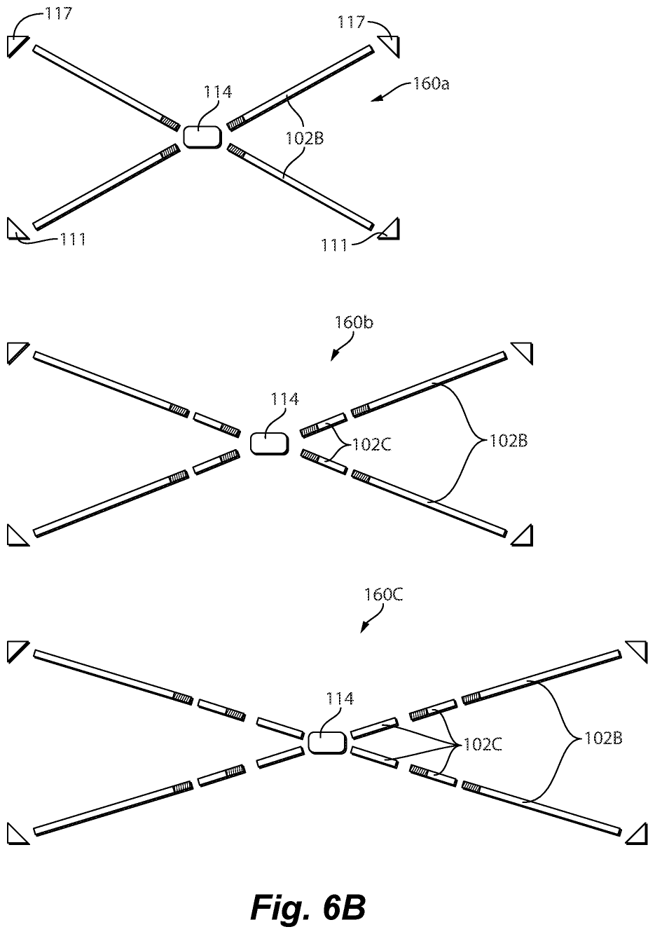

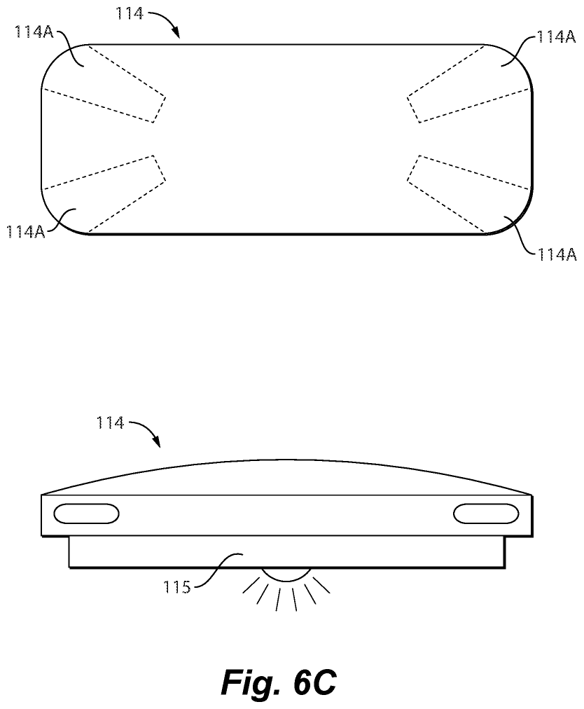

Referring to FIG. 5C, rear corner bracket 107 of top-peripheral frame 144 includes hollow tubular sections 107A defining channels 107A(1), 107A(2) configured to receive corresponding end portions of detachable rods 102A of top-peripheral frame 144, hollow tubular section 107B defining channel 107B(1) configured to receive a transverse member of top-center frame 160 (further discussed below with respect to FIG. 6A), and knob portion 107C over which an upper portion of gas spring 103 snap fits. Rear corner bracket 107 additionally includes a flange portion 148 which connects and maintains a rigid relative orientation of tubular sections 107A, 107B.

In certain embodiments, channel 107B(1) and/or tubular section 107B of rear corner bracket 107 may be conically shaped and configured to receive an end of transverse member 102B of the top-center frame 160 (FIG. 6A) of top assembly 102. Such conical shape of channel 107B(1) allows for movement of an end of a transverse member 102B lodged or wedged therein, and/or expansion or contraction thereof.

Cam locks (not shown) may be provided which interface to rear corner bracket 107 and front corner bracket 111 to lock them to transverse detachable rods 102B of top-center frame 160 (FIG. 6A). As further described below with respect to FIGS. 6A-6C, because of compression in rods 102B as they bow convexly toward the center of top assembly 102, rods 102B have a tendency to outwardly bias brackets 107, 111. In certain embodiments, detachable rods 102A may be threadably engaged or press fit into channels 107A(1), 107A(2) of brackets 107, 111, and thus provide a counter-force against the outward bias of transverse rods 102B. In other embodiments, detachable rods 102A may simply be more loosely inserted into brackets 107, 111, and standard cam locks may be used to help hold top assembly 102 together by compressing tubular section 107B to reduce the volume of 107B(1).

It will be appreciated that connection of bracket 107 to hinge portion 109A of bracket 109 (which is fixed to side member 104 of bottom assembly 101 as shown in FIGS. 4D and 5D-5E) will also provide a counter force to the outward bias of transverse rods 102B and help hold top assembly 102 together. It will also be appreciated that conically shaped channel 107B(1) allows for play in the end of rods 102B while providing counterforces thereto, thus maintaining top assembly 102 together without use of additional extraneous parts. As an alternative to cam locks, a carter pin or other straight pin that passes through rods 102B may similarly be utilized to help prevent rods 102B from potentially snapping out of place. A lift handle may also be provided to raise and lower top assembly 102. As shown in FIG. 5E, rear corner bracket 107 connects to rotating hinge portion 109A of bracket (e.g., plastic hardware) 109. Bracket 109 can be preinstalled into elongate detachable member 104 as illustrated, for example, in FIG. 4D.

In certain embodiments, one or both front corner brackets 111 may be equipped with an optional lift handle manually operable to transition cover assembly 100 from a closed configuration to an opened configuration and vice versa. Reinforcement material (e.g., plastic) may be incorporated to support the optional lift handle and can better prevent the lift handle from breaking from overuse.

Referring now to FIG. 6A, top-center frame 160 of top assembly 102 includes a top center member (e.g., cap) 114 and a plurality of transverse members (e.g., rods) 102B extending between and configured to detachably couple to corner brackets 107, 111 as described above. As shown, transverse rods 102B are straight in a relaxed, unloaded state, but bendable into an arcuate shape when connected to center member 114 and one of brackets 107, 111 as best shown in FIG. 3. When assembled, rods 102B bow convexly towards top center cap 114 of cover 100 to create a domed convex curvature of protective covering 122. In certain embodiments, transverse rods 102B can be configured as elongate tubular members which thread together and are received by brackets 107, 111 (as described above) and by top center cap 114.

Referring to FIG. 6B top-center frame 160 may be constructed using configurations 160a, 160b, 160c. Similar to FIG. 5B, front and rear brackets 111, 117 are shown schematically. Intermediary members 102C are utilized to increase the modularity of top-center frame 160 and enable resizing thereof in harmony with top-peripheral frame 144 (FIG. 5A). As shown, top-center frame 160a does not have any intermediary members 102C, top-center frame 160b has two intermediary members 102C attached thereto, and top-center frame 160c has four intermediary members 102C attached thereto. In this manner, intermediary members 102C may be used to increase or decrease the length, width, and/or height of top-center frame 160.

It will be appreciated that for a given set of top-center frame 160 components, if the overall footprint of cover 100 is decreased and brackets 111, 117 are moved closer together, transverse rods 102B will be forced into an increasingly curved configuration, thus raising the height of protective covering 122 in the closed configuration of FIG. 3. Alternatively, if the overall footprint of cover 100 is increased (e.g., brackets 111, 117 are moved further apart), then transverse rods 102B will be straighter when assembled and lower the height of protective covering 122. Intermediary members 102C may thus be utilized to raise or lower the height of the protective covering 122, or to simply allow for an increased length or width of top-center frame 160 for a given height of protective covering 122. Rods 102B and 102C may be threaded together or coupled in any other suitable manner. Alternatively, the length of intermediate detachable rods 102C of FIG. 6B may be varied relative to corresponding rods 102C used to expand the rectangular portion of top assembly 102. Various configurations and length ratios may be utilized to alter the width and height of cover assembly 100.

Referring to FIG. 6C, center cap 114 defines receiving holes 114A that are elongated and funnel shaped to receive rods 102B or 102C, and accommodate top assembly 102 with one or more intermediate detachable rods 102C such that their ends meet center cap 114 at varying angles. The resulting compression in rods 102B and/or 102C keeps top assembly 102 stable. No additional parts are required for assembly. Center cap 114 may include a light source 115 which may, for example, operate on batteries and include a motion sensor and a light sensor. Light source 115 may also include a magnetic strip for attaching to the underside of top center cap 114.

Referring again to FIGS. 1-3, protective covering 122 may also be modular and utilize or not utilize one or more intermediary pieces. Protective covering may be configured as a non-resilient screen, netting, or flexible plastic material without holes in it, and may be used for keeping insects, rain, sun, wind, morning dew, pollen, dust, pollutants, and other debris from contacting food or other items placed within cover assembly 100.

In certain embodiments, a clear vinyl cover can be added to protective covering 122 to transform protective covering 122 into a temporary tabletop green house. One or more screens can be attached to one another and top assembly 102 by a variety of means including hook and loop strips, straps, wrap around, and the like. Protective covering 122 is preferably stretchable and pulled over top assembly to provide coverage as shown in FIGS. 1-3.

While FIG. 3 shows protective covering 122 assembled over top assembly 102 and resting on top of bottom assembly 101, it will be appreciated that in this closed configuration, protective covering 122 may alternatively be tucked under bottom frame 126 of bottom assembly 101 and sandwiched between bottom frame 126 and flat surface 120. It will also be appreciated that in the open configuration of FIGS. 1-2, protective covering 122 such as netting which has holes in it will allow wind to pass through it, and thus not apply as much overturning force to cover 100.

As described herein, once disassembled, the individual components of cover assembly 100 can be compactly stored with minimal space, packaged, and/or easily transported manually, such as within a carrying case. The lightweight and compact materials of the components of cover assembly 100 enable cover assembly 100 to be disassembled and stored with ease, and transported wherever needed.

Various individual components of cover assembly 100 may be formed from a variety of materials, including without limitation, Polyvinyl Chloride (PVC), Acrylonitrile Butadiene Styrene (ABS), vinyl, acrylic, or similar plastics, tubular aluminum, tubular stainless steel, nylon, polyester, etc. Threaded engagements described herein may utilize male and female threaded ends on connecting components for easy screw on/off attachment and detachment. Hinge pins and brackets described herein may be made from zinc coated steel or aluminum. Corner brackets and center members described herein may be made from molded, machined, printed nylon, PVC, ABS or similar plastic. Gas springs described herein may be configured with, for example, a 3-4″ stroke with 3-5 lbs. of power. Protective coverings described herein may be made from nylon or polyester insect screens, rip stop nylon, water resistant polyester, clear or opaque vinyl, acrylic, or quarter inch braided elastic.

As described herein, various assemblies of cover 100 may utilize a modular design. Such modular assemblies may be assembled, disassembled, or reassembled using color coded, dry fit, internal straight and ninety-degree connectors. The fully assembled cover assembly 100 maintains its shape through compressive and frictional forces without the need for any additional hardware assembly.

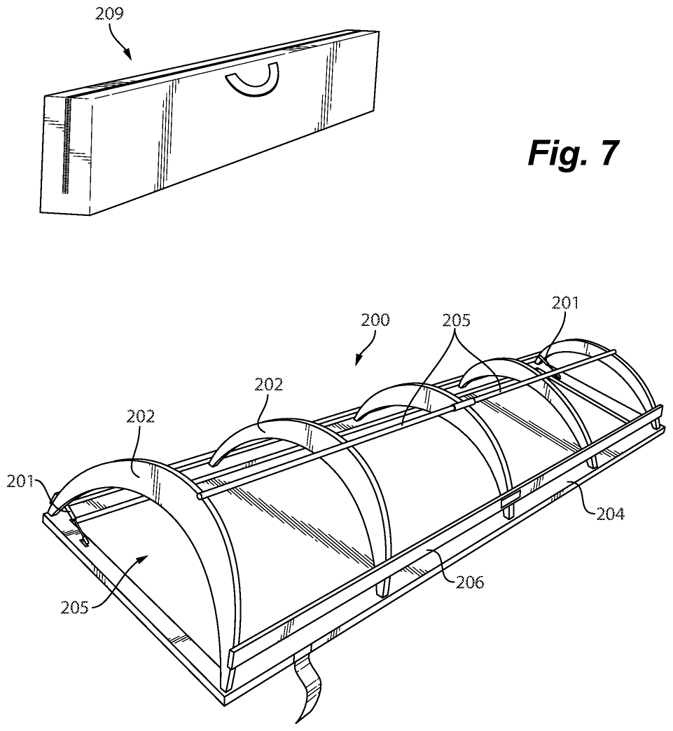

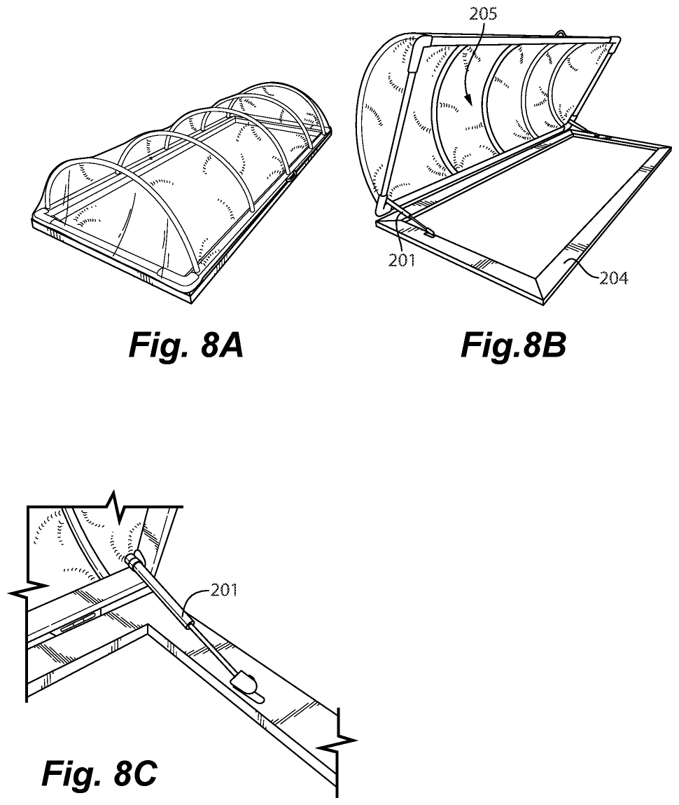

Referring now to FIG. 7, in an alternative embodiment, cover assembly 200 discloses a dome-shaped configuration for a portable and modular cover. Cover assembly 200 includes a base frame 204 that may be configured the same as or similar to bottom frame 126 of cover assembly 100, and gas springs 201 which may be the same or similar to gas springs 103 of cover assembly 100 for maintaining an open configuration after lifting top frame 205. FIGS. 8A-8B show an alternative embodiment of cover assembly 200 in closed and open configurations, respectively. As shown, top frame 205 separates from base frame 204 and is held in the open configuration by gas springs 201. FIG. 8C is a closeup view of a gas spring 201 and one manner in which it may be coupled to base frame 204 and top frame 205.

Continuing with FIG. 7, cover assembly 200 includes a plurality of ribs 202 that may be constructed, for example, from molded PVC. Each rib 202 is arcuate or U-shaped to support a domed shape for a protective covering that may be placed over top frame 205, similar to protective covering 122 described above with respect to cover assembly 100. Although FIG. 7 depicts a set of five ribs 202, cover assembly 200 can be constructed with as few as two ribs 202 or more than five. The U-shape or arched shape of ribs 202 enhances cover assembly 200's overall structural stability and adds to the relative simplicity of its construction. Ribs 202 are connected in the front and back by two or more linear pieces of PVC strips 206.

As shown, ribs 202 may be configured thinner at bottom and wider toward the top thereof to give the frame rigidity, and to support insect screening, for example. Such added material in the middle also allows for notching to receive the longitudinal PVC Strips 206. For example, strips 206 may couple to the ribs 202 via cutout portions on each rib 202 that can snap onto the edge surfaces of strips 206 via press-fit or interference fit. For example, by slightly undersizing the cutout portions on strips 206 as compared to the edge surfaces of ribs 202, ribs 202 will stay in place due to friction caused by compressing the elastic rib 202 material into the cutout portions. Although not shown in FIG. 7, rear strip 206 is preferably hinged to the rear elongate portion of base frame 204 at locations adjacent to both gas springs 201. Any hinge mechanism known in the art may be utilized.

Gas spring 201 can be manually removed and attached on both ends of base frame 204. In one embodiment, gas spring 201 may snap onto each rib 202 located at opposite ends of top frame 205 and base frame 204 by coupling to knobs similar to those disclosed in rear corner brackets 107 of cover assembly 100.

Cover assembly 200 also comprises rods 205 that may be the same or similar to rods 102A or 102B disclosed in cover assembly 100, or alternatively constructed from the same material as base frame 204. Rods 205 couple to the top center edge of each rib 202 by snapping into place in a manner similar to how strips 206 couple to ribs 202. Optionally and as illustrated in FIG. 7, strips 206 and rods 205 may each comprise two detachable members, which meet at and are both coupled to middle rib 202. This reduces the overall size of the individual components of cover assembly 200 to provide for easier storage and transportation when disassembled.

Any protective covering such as a screen or cover depicted in the embodiment depicted in FIG. 7 or FIGS. 8A and 8B, or disclosed in cover assembly 100, can be attached to top frame 205. It is purposeful for the ends of ribs 202 to extend beyond the bottom edge of strips 206. This enables an elastic portion of the screen or cover to be tucked under each rib 202 protrusion in both the front and back. The screen or cover may be sized appropriately to ensure that when stretched over the ends of ribs 202, it remains fairly taunt at its bottom. Alternatively, the ends of the screen or cover may be sized to accommodate being tucked further under the bottom frame 204.

A carrying case 209 may be any suitable case to transport cover assembly 200, cover assembly 100, or any other embodiment such as cover assembly 300 (described below) when fully disassembled.

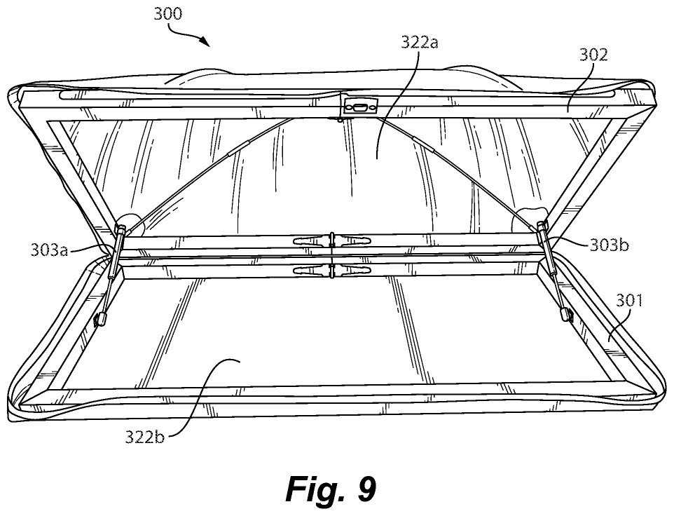

Referring now to FIG. 9, in yet another alternative embodiment, cover assembly 300 discloses a configuration to facilitate further ease of assembly and disassembly without the use of wrenches, screwdrivers, or other extraneous tools. As shown in FIG. 9, cover assembly 300 is configurable to an open configuration, and includes a bottom frame 301 and top frame 302. By way of example as depicted in FIG. 9, the bottom frame 301 and top frame 302 may be made of the same material and have the same or similar dimensions. For example, bottom frame 301 and top frame 302 may be made of a series of lightweight tubular PVC or similar plastic, tubular aluminum, or tubular stainless-steel members. One or more gas springs 303a, 303b enable cover assembly 300 to stay in its open configuration without user engagement, and to facilitate a smooth opening and closing of cover assembly 300.

Still referring to FIG. 9, a protective covering 322 that consists of a top portion 322a and a bottom portion 322b wraps around top frame 302 and bottom frame 301, respectively. In this embodiment, the bottom portion 322b of protective covering 322 provides a bottom surface for placing food or other objects within cover assembly 300. Therefore, cover assembly 300 does not rely on a separate flat surface 120 for placement of food or other items like cover assembly 100. It will be appreciated, however, that all embodiments disclosed herein may alternatively utilize a wrap-around protective covering such as or similar to protective covering 322.

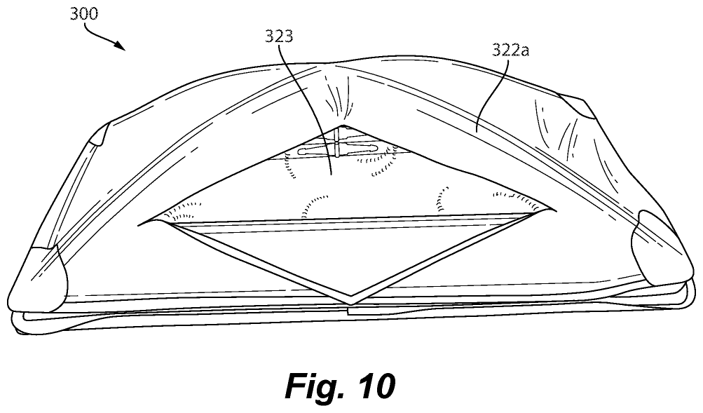

Referring to FIG. 10, cover assembly 300 is configurable to a closed configuration. The protective covering 322 may be secured to top frame 302 and bottom frame 301 by any suitable means including Velcro or other self-mating reclosable fasteners. In one embodiment of protective covering 322, the top portion 322a has a window portion 323 to enable a user to view the inside of cover assembly 300 without having to fully or partially open it. The window portion 323 may be opened and closed by any suitable means including a zipper means as depicted in FIG. 10. Alternatively, and like other embodiments disclosed herein, protective covering 322 may be partially transparent obviating the need for a window portion 323.

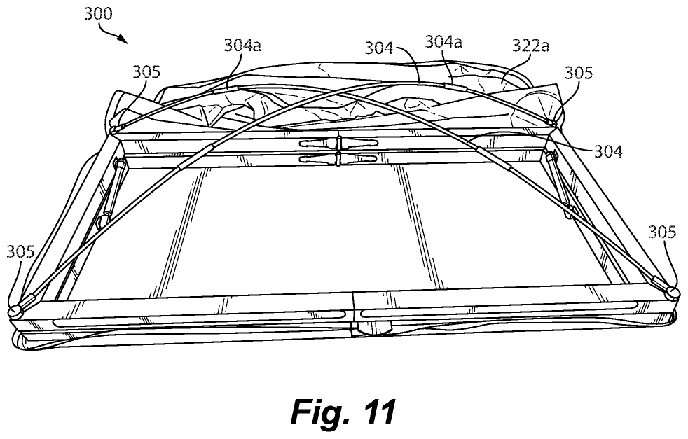

Referring now to FIG. 11, top portion 322a of protective covering 322 has been removed from top frame 302 to reveal transverse rods 304. The ends of each transverse rod 304 fits within tubular receiving sections in hardware 305. There are four separate hardware 305 that are secured to the four corners of an assembled top frame 302 by any suitable means, and hardware 305 may preferably be secured to enable at least slight rotation to better accommodate receipt of the ends of each transverse rod 304. In some embodiments, transverse rods 304 and hardware 305 threadably engage. Like other embodiments described herein, the transverse rods 304 are straight in a relaxed, unloaded state, but bendable into an arcuate shape when connected transversely into opposite and complementary hardware 305. When assembled, the length of the transverse rods 304 create a domed convex curvature when top portion 322a of protective covering 322 is attached to top frame 302. In certain embodiments, transverse rods 304 may comprise multiple rod components which thread or otherwise connect to each other at one or more sections 304a as depicted in FIG. 11. This may facilitate inclusion within a compact carrying case. In certain embodiments, transverse rods 304 may be lightweight fiberglass rods.

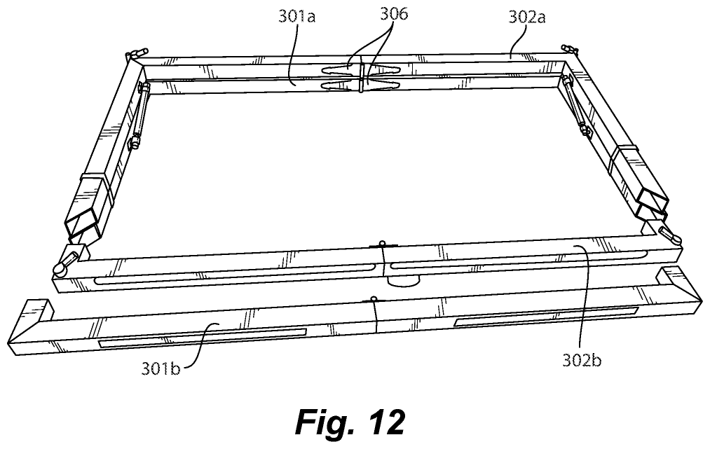

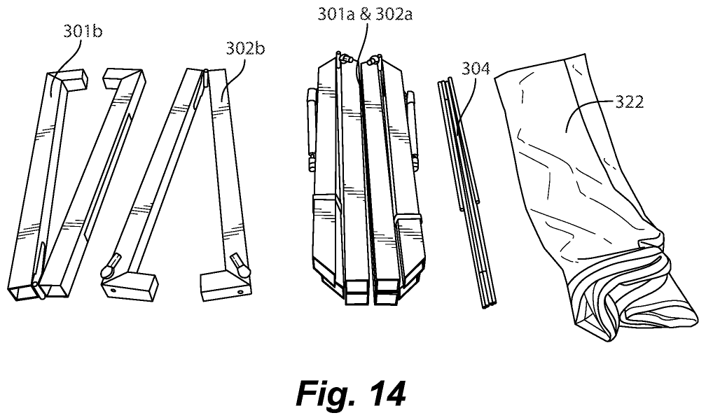

Referring now to FIG. 12, top frame 302 and bottom frame 301 comprise front portions 302b and 301b, respectively, and rear and side portions 302a and 301a, respectively. In the embodiment depicted in FIG. 12, both front portions 302b and 301b have ends that can slidably and removably couple with and receive the ends of corresponding rear and side portions 302a and 301a to form complete rectangular top frame 302 and bottom frame 301. Front portions 302b and 301b and corresponding rear and side portions 302a and 301a may slidably couple together by, for example, friction or other snap fit components or joints as are commonly known in the art. Further, front portions 302b and 301b may each comprise two separate front portion members that are affixed together by any suitable means, including a hinge (not visible in FIG. 14, but may be the same or similar to hinge 306). Similarly, rear and side portions 302a and 301a may each comprise one or more rear portion members and two or more side portion members that are affixed together by any suitable means, including hinges such as or similar to hinge 306. By way of example, the embodiment illustrated in FIGS. 12-14 consists of rear and side portions 302a and 301a that are each constructed from four separate lightweight tubular members: two rear members coupled by a hinge at their respective medial ends, and two side members coupled to the rear members at the rear members' respective distal ends. And the embodiment illustrated in FIGS. 12-14 further consists of front portions 302b and 301b that are each constructed from two separate “L-shaped” lightweight tubular members that are coupled by a hinge at their respective medial ends. The distal ends of the coupled “L-shaped” lightweight tubular members 302b and 301b are slidably and removably coupled to corresponding distal ends of the side members of 302a and 301a, respectively, to complete rectangular top frame 302 and rectangular bottom frame 301.

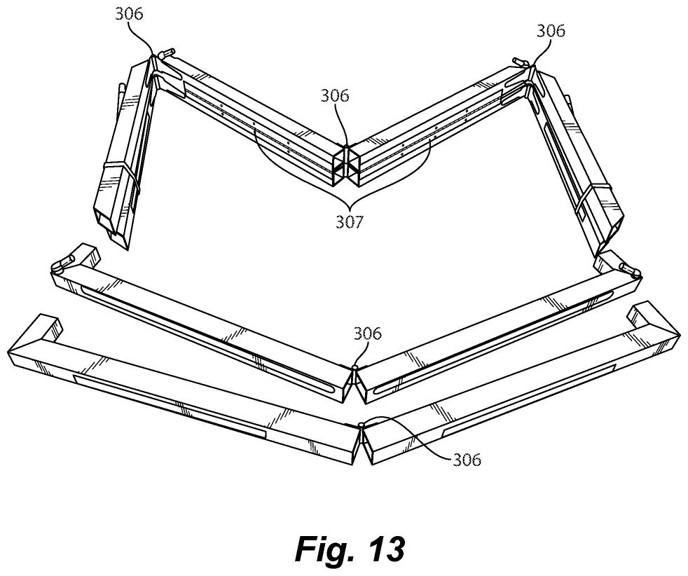

Referring to FIGS. 12-13, examples of hinge placements that facilitate the collapsibility of top frame 302 and bottom frame 301 are shown. Where indicated, a hinge 306 enables top frame 302 and bottom frame 301 to separate and rotate about its respective front, rear, and side portion members accordingly. In one embodiment, the rear and side portions 302a and 301a are affixed together by elongated hinges 307 (which would be located on the outside rear of an assembled cover assembly 300) such as a continuous hinge or piano hinge. Elongated hinges 307 in conjunction with gas springs 303a, 303b, which are coupled on one end to bottom frame 301 and coupled on the opposite end to top frame 302, enable cover assembly 300 to be opened and closed. Gas springs 303a, 303b may be preinstalled or removably coupled (for example, by snap fitting like gas spring 103 as described in other embodiments).

The various hinges described herein may be implemented with locking hinges as are commonly known in the art or, by way of further example, hinges that are biased towards an open configuration or biased towards both an open or closed configuration depending on whether the hinge is rotated closer to an extended or collapsed position. Such hinges as known in the art may be utilized to facilitate greater stability of the cover assembly embodiments when fully assembled for outdoor use.

Referring now to FIG. 14, top frame 302 and bottom frame 301 are shown in a collapsed state as a result of rotating their respective front, rear, and side portion members about all available hinges 306. The transverse rods 304 in this embodiment have their respective rod components unthreaded at one or more sections 304a to further facilitate compact storage. A protective covering 322 is removed from top frame 302 and bottom frame 301 and in this illustration folded for storage/transport.

The components of cover assembly 300 are easily stored in a suitable carrying case. Because of the hinge 306 construction for top frame 302 and bottom frame 301, and the unthreaded transverse rods 304, the cover assembly 300 can be easily transported and set up with minimal effort and without the use of wrenches, screwdrivers, or other extraneous tools.

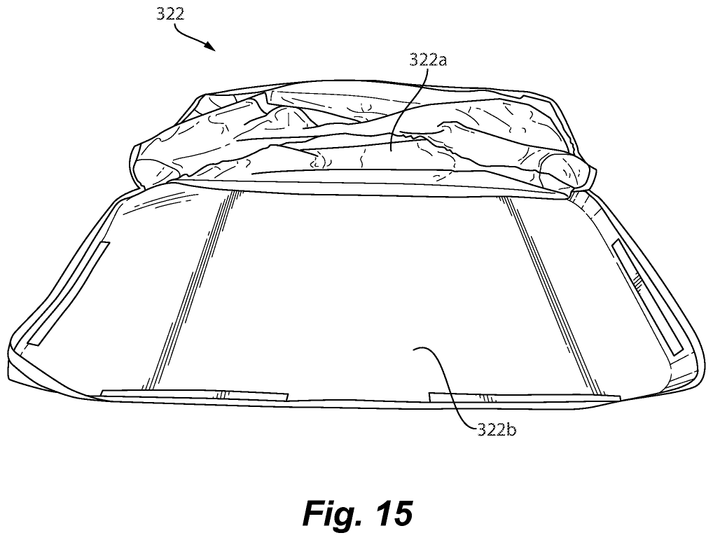

Referring now to FIG. 15, protective covering 322 is shown. Both the top portion 322a and bottom portion 322b are lined with either the loop or hook side of a Velcro, although other self-mating reclosable fasteners may be used. The opposite sides of a Velcro for fastening protective covering 322 to top frame 302 and bottom frame 301 are visible in FIGS. 13 and 15 as elongate black strips which are affixed to appropriate sides of front portions 302b and 301b and rear and side portions 302a and 301a. When cover assembly 300 is closed, its protective covering 322 may include a zipper or other fastening mechanism between its top portion 322a and bottom portion 322b to further secure the contents within cover assembly 300 while in a closed configuration.

To the extent any one of the disclosed embodiments and its respective components have been described as preferably and/or optionally being manufactured with specific or general materials or types of hardware, it is understood that all of the other disclosed embodiments and their respective components may preferably and/or optionally be manufactured with the same specific or general materials or types of hardware. For example, all embodiments of the invention may include a light source such as or similar to that depicted in FIG. 6C.

It will be appreciated that the cover assemblies described herein may be utilized for a wide variety of activities and assembled in many different structural layouts. The cover assembly components are easily transported to a location and assembled into an operational, modular, stable device whose size is adaptable as needed, all without use of extraneous tools.

The present invention has been described in the context of a number of embodiments, and multiple variations and examples thereof. It is to be understood, however, that other expedients known to those skilled in the art or disclosed herein may be employed without departing from the spirit of the invention. It is also to be understood that aspects of certain disclosed embodiments may be incorporated into other embodiments.

Any references to the “invention” herein do not and are not intended to identify or describe aspects or embodiments that are required or otherwise essential to the present invention unless expressly stated as such.

What is claimed is:

1. A cover assembly, comprising:
a covering;
a rear bottom frame, comprising:
a left rear bottom member rotatably coupled to a right rear bottom member;
a left side bottom member rotatably coupled to the left rear bottom member; and
a right side bottom member rotatably coupled to the right rear bottom member;
a front bottom frame, comprising:
a left front bottom member rotatably coupled to a right front bottom member;
a rear top frame, comprising:
a left rear top member rotatably coupled to a right rear top member;
a left side top member rotatably coupled to the left rear top member; and
a right side top member rotatably coupled to the right rear top member; and
a front top frame, comprising:
a left front top member rotatably coupled to a right front top member, wherein:
the rear bottom frame is coupled to the front bottom frame and forms a bottom frame; and
the rear top frame is coupled to the front top frame and forms a top frame, wherein:
a first transverse rod in an arcuate shape extends from a front left corner of the top frame to a rear right corner of the top frame; and
a second transverse rod in an arcuate shape extends from a rear left corner of the top frame to a front right corner of the top frame, whereby the first transverse rod and the second transverse rod define a domed convex area upon which the covering extends over.

2. The cover assembly of claim 1, wherein the top frame is configurable to both a closed configuration and an open configuration.

3. The cover assembly of claim 1, further comprising one or more gas springs coupled at a first end to the rear bottom frame, and coupled at a second end to the rear top frame.

4. The cover assembly of claim 1, further comprising a plurality of hardware each with a tubular receiving section for engaging with an end from one of the group consisting of: (A) the first transverse rod, and (B) the second transverse rod.

5. The cover assembly of claim 1, wherein the first transverse rod comprises a plurality of rod segments, and the second transverse rod comprises a plurality of rod segments.

6. The cover assembly of claim 1, further comprising a light source.

7. The cover assembly of claim 1, wherein the covering wraps around the bottom frame and the top frame and forms a surface underneath the bottom frame.

8. A cover assembly, comprising:
a covering;
a bottom frame;
a top frame;
a first transverse rod in an arcuate shape that extends from a front left corner of the top frame to a rear right corner of the top frame; and
a second transverse rod in an arcuate shape extends from a rear left corner of the top frame to a front right corner of the top frame, whereby the first transverse rod and the second transverse rod define a domed convex area upon which the covering extends over, wherein:
the top frame is rotatably coupled to the bottom frame whereby the top frame is configurable to both a closed configuration and an open configuration.

9. The cover assembly of claim 8, further comprising one or more hinges coupling the top frame to the bottom frame.

10. The cover assembly of claim 8, further comprising a plurality of hardware each with a tubular receiving section for engaging with an end from one of the group consisting of: (A) the first transverse rod, and (B) the second transverse rod.

11. The cover assembly of claim 8, wherein the first transverse rod comprises a plurality of rod segments, and the second transverse rod comprises a plurality of rod segments.

12. The cover assembly of claim 8, further comprising a light source.

13. The cover assembly of claim 8, wherein the covering wraps around the bottom frame and the top frame and forms a surface underneath the bottom frame.

14. A cover assembly, comprising:
a covering;
a bottom frame, comprising:
a rear bottom frame; and
a front bottom frame;
a top frame, comprising:
a rear top frame; and
a front top frame, wherein:
a first transverse rod in an arcuate shape extends from a front left corner of the top frame to a rear right corner of the top frame; and
a second transverse rod in an arcuate shape extends from a rear left corner of the top frame to a front right corner of the top frame, whereby the first transverse rod and the second transverse rod define a domed convex area upon which the covering extends over.

15. The cover assembly of claim 14, wherein the top frame is rotatably coupled to the bottom frame whereby the top frame is configurable to both a closed configuration and an open configuration.

16. The cover assembly of claim 14, further comprising one or more gas springs coupled at a first end to the rear bottom frame, and coupled at a second end to the rear top frame.

17. The cover assembly of claim 14, further comprising a plurality of hardware each with a tubular receiving section for engaging with an end from one of the group consisting of: (A) the first transverse rod, and (B) the second transverse rod.

18. The cover assembly of claim 14, wherein the first transverse rod comprises a plurality of rod segments, and the second transverse rod comprises a plurality of rod segments.

19. The cover assembly of claim 14, further comprising a light source.

20. The cover assembly of claim 14, wherein the covering wraps around the bottom frame and the top frame and forms a surface underneath the bottom frame.
